(19) United States
(12) Patent Application Publication
(10) Pub. No.: US 2005/0106088 A1
(43) Pub. Date: May 19, 2005

(54) Halogen-containing gas absorbent, halogen-containing gas removal method,and halogen-containing gas processing apparatus

(76) Inventors: Masahiro Kato, Naka-gun (JP); Kazuaki Nakagawa, Tokyo (JP); Sawako Yoshikawa, Yokohama-shi (JP); Kenji Essaki, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/935,104

(22) Filed: Sep. 8, 2004

(30) Foreign Application Priority Data
Sep. 11, 2003 (JP) 2003-319963

(51) Int. Cl. B01J 20/34; B01J 38/60; C01B 33/32; C01G 25/02

(52) U.S. Cl. 423/240 S; 423/332; 423/594.12; 423/594.2; 423/594.4; 423/598; 423/600; 502/400

(57) ABSTRACT

A halogen-containing gas absorbent comprising a lithium-containing composite oxide such as lithium silicate having an average particle diameter of 50 μm to 3 mm can absorb a halogen-containing gas regardless of the water vapor amount in an ambient.

### CROSS-REFERENCE TO RELATED APPLICATIONS

This application is based upon and claims the benefit of priority from prior Japanese Patent Application No. 2003-319963, filed Sep. 11, 2003, the entire contents of which are incorporated herein by reference.

### BACKGROUND OF THE INVENTION

1. Field of the Invention

The present invention relates to a halogen-containing gas absorbent, a method of removing a halogen-containing gas from a gas to be processed which contains the halogen-containing gas by using the halogen-containing gas absorbent, and a halogen-containing gas processing apparatus.

2. Description of the Related Art

A semiconductor device fabrication method has a step of performing dry etching for a film on a semiconductor substrate by using a dry etching gas matching the properties of the film. As this dry etching gas, a halogen-containing gas such as hydrofluoric acid gas or chlorine trifluoride is mixed in an inert gas as a carrier gas, and the gas mixture is supplied to dry etching. This halogen-containing gas is highly dangerous and toxic. When the dry etching gas is exhausted, therefore, the halogen-containing gas must be removed from the inert gas.

A wet method and dry method are known as the conventional halogen-containing gas removal methods.

The wet method uses an aqueous alkali solution as a halogen-containing gas absorbing solution. This method has the problem that the efficiency of removal of a very small amount of a halogen-containing gas is low.

The dry method uses particles having two types of alkali components as a halogen-containing gas absorbent. In this method, gas collection is also relatively simple. For example, when soda lime (NaOH, Ca(OH)₂, H₂O) is used as an absorbent to process hydrogen chloride gas, reactions indicated by
HCl+H₂O→H₃ClO (1)
H₃ClO+NaOH→NaCl+2H₂O (2)
NaCl+1/2Ca(OH)₂→1/2CaCl₂+NaOH (3)
occur in turn to absorb and remove the hydrogen chloride gas.

To remove a halogen-containing gas by soda lime, however, water is necessary as indicated by formula (1) above. If a gas to be processed which contains a halogen-containing gas is a dried gas such as a dry etching gas, the water in the absorption reaction field evaporates. This makes it difficult to absorb and remove a halogen-containing gas contained in a dry etching gas by using soda lime.

Jpn. Pat. Appln. KOKAI Publication No. 9-99216 discloses a halogen-containing gas absorbent which suppresses the decrease in halogen-containing gas absorbing capacity caused by the reduction in water amount by using strontium hydroxide instead of NaOH. However, since water is essential in the reaction of this invention, the absorption of a halogen-containing gas in a dried ambient is limited, so the absorbent must be frequently interchanged.

As described above, when a halogen-containing gas is removed by the wet method, collection of the halogen-containing gas is difficult. The dry method using particles containing alkali components is hardly applicable to a dried gas to be processed which contains a halogen-containing gas.

### BRIEF SUMMARY OF THE INVENTION

The present invention provides a halogen-containing gas absorbent capable of efficiently absorbing a halogen-containing gas in a dried gas to be processed.

According to a first aspect of the present invention, there is provided a halogen-containing gas absorbent comprising lithium-containing composite oxide particles having an average particle diameter of 50 μm to 3 mm.

According to a second aspect of the present invention, there is provided a halogen-containing gas absorbent comprising porous lithium-containing composite oxide particles having an average particle diameter exceeding 3 mm and not more than 30 mm, and a porosity of 30% to 70%.

According to a third aspect of the present invention, there is provided a halogen-containing gas removal method comprising bringing a gas to be processed which contains a halogen-containing gas, into contact with a halogen-containing gas absorbent containing lithium-containing composite oxide particles having an average particle diameter of 50 μm to 3 mm.

According to a fourth aspect of the present invention, there is provided a halogen-containing gas removal method comprising bringing a gas to be processed which contains a halogen-containing gas, into contact with a halogen-containing gas absorbent containing porous lithium-containing composite oxide particles having an average particle diameter exceeding 3 mm and not more than 30 mm, and a porosity of 30% to 70%.

According to a fifth aspect of the present invention, there is provided halogen-containing gas processing apparatus comprising:
a vessel having a supply port through which a gas containing a halogen-containing gas is supplied, and an exhaust port; and
a halogen-containing gas absorbent packed in the vessel and containing lithium-containing composite oxide particles having an average particle diameter of 50 μm to 3 mm.

According to a sixth aspect of the present invention, there is provided a halogen-containing gas processing apparatus comprising:
a vessel having a supply port through which a gas containing a halogen-containing gas is supplied, and an exhaust port; and
a halogen-containing gas absorbent packed in the vessel and containing porous lithium-containing composite oxide particles having an average particle diameter exceeding 3 mm and not more than 30 mm, and a porosity of 30% to 70%.

### BRIEF DESCRIPTION OF THE SEVERAL VIEWS OF THE DRAWING

The single FIGURE is a sectional view showing a halogen-containing gas processing apparatus according to an embodiment of the present invention.

### DETAILED DESCRIPTION OF THE INVENTION

### FIRST EMBODIMENT

A halogen-containing gas absorbent according to the first embodiment contains lithium-containing composite oxide particles having an average particle diameter of 50 μm to 3 mm.

Examples of the lithium-containing composite oxide are lithium silicate, lithium zirconate, lithium ferrite, lithium nickelate, lithium titanate, and lithium aluminate. The halogen-containing gas absorbent according to the first embodiment contains one or a mixture of these compound oxides.

The lithium-containing composite oxide can be manufactured by causing a metal oxide powder, such as silicon oxide, zirconium oxide, iron oxide, nickel oxide, titanium oxide, or aluminum oxide powder, to react with lithium carbonate powder. The metal oxide powder and lithium carbonate powder preferably have an average particle diameter of 0.1 to 20 μm. For example, lithium silicate and lithium zirconate are manufactured by reactions indicated by
SiO₂+2Li₂CO₃→Li₄SiO₄+2CO₂ (4)
ZrO₂+Li₂CO₃→Li₂ZrO₃+CO₂ (5)

The reaction temperatures for forming lithium silicate, lithium zirconate, lithium ferrite, lithium nickelate, lithium titanate, and lithium aluminate as the lithium-containing composite oxides are 400° C. or more, 500° C. or more, 300° C. or more, 400° C. or more, 400° C. or more, and 500° C. or more, respectively. These reactions are reversible, so the lithium-containing composite oxides return to the metal oxides if the reaction temperatures become lower than the above temperatures. Accordingly, it is desirable to prevent the manufactured lithium-containing composite oxide from reverting to the metal oxide by storing the lithium-containing composite oxide in an environment such as a closed vessel shielded from carbon dioxide.

The above lithium-containing composite oxides absorb a halogen-containing gas, e.g., hydrogen chloride gas, by reactions indicated by
Li₄SiO₄(s)+4HCl→4LiCl(s)+SiO₂(s)+2H₂O (6)
Li₂SiO₃(s)+2HCl→2LiCl(s)+SiO₂(s)+H₂O (7)
Li₂ZrO₃(s)+2HCl→2LiCl(s)+ZrO₂(s)+H₂O (8)
2LiFeO₂(s)+2HCl→2LiCl(s)+Fe₂O₃(s)+H₂O (9)
2LiNiO₂(s)+2HCl→2LiCl(s)+Ni₂O₃(s)+H₂O (10)
Li₂TiO₃(s)+2HCl→2LiCl(s)+TiO₂(s)+H₂O (11)
2LiAlO₂(s)+2HCl→2LiCl(s)+Al₂O₃(s)+H₂O (12)

As indicated by formulas (6) and (7), lithium silicate takes the forms of two different compounds. Lithium silicate (Li₄SiO₄) indicated by formula (6) can absorb and collect a halogen-containing gas in an amount (molar ratio) theoretically twice that of the lithium-containing composite oxides indicated by formulas (7) to (12).

Examples of the halogen-containing gas other than hydrogen chloride gas are fluorine gas, hydrogen fluoride gas, chlorine gas, hydrogen chloride gas, chlorine fluoride gas, bromine gas, hydrogen bromide gas, iodine gas, and hydrogen iodide gas. When hydrogen chloride gas is absorbed by using Li₄SiO₄ as a lithium-containing composite oxide, the reaction is indicated by
Li₄SiO₄(s)+ClF₃(s)→3LiF(s)+LiClO₂(s)+SiO₂ (13)
When hydrogen fluoride gas is absorbed by using the same lithium-containing composite oxide, the reaction is indicated by
Li₄SiO₄(s)+4HF(s)→4LiF(s)+SiO₂(s)+2H₂O (14)

Note that the reactions indicated by formulas (6) to (14) occur at room temperature.

When the average particle diameter of the lithium-containing composite oxide particles described above is in the range of 50 μm to 3 mm, a halogen-containing gas can be efficiently absorbed. If the average particle diameter of the lithium-containing composite oxide particles is less than 50 μm, the particles densely gather, decreasing the spacings between them. This makes it difficult to ensure the flow rate of a gas to be processed, such as a gas containing a halogen-containing gas, which flows between the particles. This may make efficient absorption of the halogen-containing gas difficult. The average particle diameter of the lithium-containing composite oxide particles is more preferably in the range of 500 μm to 2 mm.

The conventional halogen-containing gas absorbent such as soda lime requires water, as indicated by formula (1) presented earlier, in order to react with a halogen-containing gas (e.g., hydrogen chloride gas). To use this absorbent in a dried gas to be processed, therefore, the moisture retention must be increased by, e.g., using coarse particles having a particle diameter of about 5 mm. In contrast, the lithium-containing composite oxides require no water to react with a halogen-containing gas as indicated by formulas (6) to (14). Accordingly, the lithium-containing composite oxides can be used in the form of particles having an average particle diameter of 3 mm or less. This increases the probability of contact with a halogen-containing gas as described above, so the halogen-containing gas can be efficiently absorbed.

The lithium-containing composite oxide particle can have an arbitrary porosity. This lithium-containing composite oxide particle having an arbitrary porosity takes the form of an aggregate (secondary particle) of fine lithium-containing composite oxide particles (primary particles) having an average particle diameter of, e.g., 0.1 to 20 μm. This secondary particle takes a form in which a plurality of primary particles directly bond to each other, or a form in which a plurality of primary particles are bonded via a binder resin. The latter secondary particle can be manufactured by a fluidized bed method or spray dry method to be explained below.

The halogen-containing gas absorbent particles according to the present invention have a substantially spherical shape such as a sphere or ellipse.

As a method of obtaining lithium-containing composite oxide particles having an average particle diameter of 50 μm to 3 mm, a rolling method, spray dry method, or the like can be used.

The rolling method is suited to manufacturing relatively large lithium-containing composite oxide particles having an average particle diameter of about 0.05 mm to about 3 mm. That is, a lithium-containing composite oxide powder having an average particle diameter of, e.g., about 0.1 μm to about 20 μm and a binder resin powder are mixed at a weight ratio of 1:0.005 to 0.1, and the mixture is placed on an inclined rotary tray. This inclined rotary tray is then rotated at about 50 to 500 rpm for about 1 to 60 minutes, thereby manufacturing lithium-containing composite oxide particles falling within the above particle diameter range from the mixture.

Examples of the binder resin used in the rolling method are PVA (polyvinyl alcohol), PVB (polyvinyl butyral), wax, paraffin, and CMC (carboxymethylcellulose). When a binder resin such as PVA or CMC is used, lithium-containing composite oxide particles having relatively large particle diameters are obtained. When a binder resin such as PVB or wax is used, lithium-containing composite oxide particles having relatively small particle diameters are obtained.

In this rolling method, as the rotation time is prolonged or the rotational speed is lowered, the average particle diameter of the obtained lithium-containing composite oxide particles increases.

The spray dry method is suited to manufacturing relatively small lithium-containing composite oxide particles about 50 μm to about 500 μm in diameter. That is, water and a binder resin are added to a lithium-containing composite oxide powder having an average particle diameter of, e.g., about 0.1 μm to about 20 μm, thereby preparing a slurry. This slurry is sprayed into a furnace in which hot wind circulates, thereby manufacturing lithium-containing composite oxide particles having particle diameters within the above range.

In this spray dry method, the size of the obtained lithium-containing composite oxide particles can be controlled by adjusting the viscosity of the slurry; the higher the viscosity of the slurry, the larger the particle diameter. More specifically, lithium-containing composite oxide particles having relatively small particle diameters of about 10 μm to about 500 μm can be manufactured by adjusting the addition amounts of the binder resin and water such that the slurry viscosity is about 10 mPa.s to about 500 mPa.s.

A halogen-containing gas removal method using the halogen-containing gas absorbent according to the first embodiment will be explained below.

At room temperature, a gas to be processed which contains a halogen-containing gas is brought into contact with a halogen absorbent containing lithium-containing composite oxide particles having an average particle diameter of 50 μm to 3 mm. Consequently, the lithium-containing composite oxide particles react with and absorb the halogen-containing gas in the gas to be processed in accordance with any of formulas 6 to 14 presented earlier. Since this reaction requires no water, the halogen-containing gas can be efficiently absorbed and removed from the dried gas to be processed. Also, since the average particle diameter of the lithium-containing composite oxide particles is in the range of 50 μm to 3 mm, the gas to be processed can be well supplied between the lithium-containing composite oxide particles. In addition, the ratio of contact with the lithium-containing composite oxide particles can be increased. This also makes it possible to efficiently absorb and remove the halogen-containing gas from the gas to be processed.

The gas to be processed preferably contains 0.1% to 5.0% by volume, of the halogen-containing gas. If the amount of halogen-containing gas in the gas to be processed falls outside this range, the efficiency of absorption of the halogen-containing gas by the absorbent may decrease.

Examples of the gas to be processed are a dried dry etching gas which is exhausted as a waste gas after dry etching and contains a halogen-containing gas and an inert gas such as argon or nitrogen, and a halogen-containing gas which is vaporized in cleaning process.

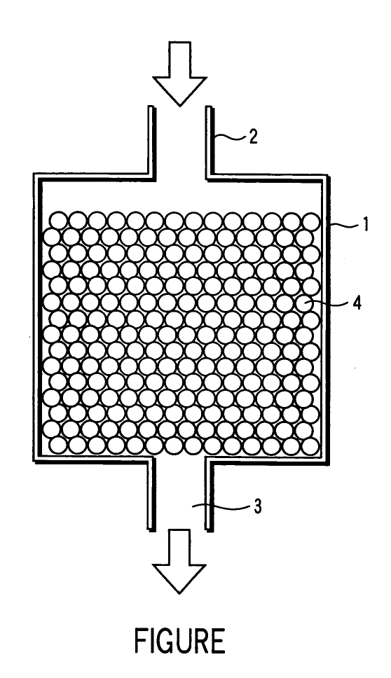

A halogen-containing gas processing apparatus including the halogen-containing gas absorbent according to the first embodiment will be described below with reference to FIG. 1.

A processing vessel 1 has, e.g., a cylindrical shape with two closed ends. A supply port 2 for a gas to be processed which contains a halogen-containing gas is formed in the upper portion of the processing vessel 1. An exhaust port 3 for exhausting the processed gas is formed in the lower portion of the processing vessel 1. The processing vessel 1 is filled with a halogen-containing gas absorbent 4 containing the lithium-containing composite oxide particles having an average particle diameter of 50 μm to 3 mm described above.

In this halogen-containing gas processing apparatus shown in FIG. 1, a gas to be processed which contains a halogen-containing gas is supplied into the processing vessel 1 through the supply port 2, and allowed to pass between the particles of the halogen-containing gas absorbent 4 packed in the vessel 1. In this state, the halogen-containing gas in the gas to be processed is absorbed by the halogen-containing gas absorbent 4. The processed gas passing between the particles of the halogen-containing gas absorbent 4 is exhausted via the exhaust port 3. By this processing apparatus, the concentration of, e.g., a halogen-containing gas in a gas to be processed can be reduced.

### SECOND EMBODIMENT

A halogen-containing gas absorbent according to the second embodiment contains porous lithium-containing composite oxide particles having an average particle size exceeding 3 mm and not more than 30 mm, i.e., 3 mm (exclusive) to 30 mm (inclusive), and a porosity of 30% to 70%. That is, relatively large particles having an average particle diameter exceeding 3 mm and not more than 30 mm have a specific porosity. The porosity is obtained from the result of measurement performed by a mercury penetration method.

This lithium-containing composite oxide is manufactured in the same manner as explained in the first embodiment, and absorbs a halogen-containing gas.

By increasing the average particle diameter of the porous lithium-containing composite oxide particles exceeding 3 mm and not more than 30 mm, it is possible to increase the spacings between the particles, and reduce the pressure loss of a gas to be processed which flows between the particles. Also, the reduction in contact ratio between the gas to be processed and the halogen-containing gas absorbent resulting from the increased average particle diameter is compensated for by a porous structure having a predetermined porosity. However, if the average particle diameter of the porous lithium-containing composite oxide particles exceeds 30 mm, the amount of gas to be processed which passes between the particles without passing through pores of the porous structure increases. This may make sufficient absorption of a halogen-containing gas impossible. The average particle diameter of the porous lithium-containing composite oxide particles is more preferably in the range of 5 mm to 20 mm.

If the porosity of the porous lithium-containing composite oxide particles having a relatively large average particle diameter is less than 30%, it becomes difficult to satisfactorily increase the contact ratio between the porous lithium-containing composite oxide particles and a gas to be processed. This may decrease the absorption ratio of a halogen-containing gas. If the porosity of the porous lithium-containing composite oxide particles exceeds 70%, the amount of halogen-containing gas absorbent itself decreases, and this may decrease the absorption amount of a halogen-containing gas. Also, if the porosity exceeds 70%, the strength of each particle may decrease too much to maintain its shape. The porosity of the porous lithium-containing composite oxide particles is more preferably in the range of 40% to 60%.

The porous lithium-containing composite oxide particle described above has the form of an aggregate (secondary particle) which is obtained by aggregating fine lithium-containing composite oxide particles (primary particles) having an average particle diameter of, e.g., 0.1 to 20 μm, and which has a predetermined porosity. This secondary particle takes a form in which a plurality of primary particles directly bond to each other so as to have a porosity of 30% to 70%, or a form in which a plurality of primary particles are bonded via a binder resin so as to have a porosity of 30% to 70%.

The halogen-containing gas absorbent particle according to the present invention has a spherical shape or a cylindrical shape. When the particle is a column, the particle diameter is the length of the column.

A method of manufacturing the halogen-containing gas absorbent according to the second embodiment will be explained below.

A halogen-containing gas absorbent containing porous compound oxide particles is manufactured by compression-molding a lithium-containing composite oxide powder having an average particle diameter of, e.g., 0.1 to 20 μm by using a mold having a predetermined size. By applying a pressure of about 500 to 1,000 kg/m² to the lithium-containing composite oxide powder in the mold, it is possible to obtain porous lithium-containing composite oxide particles having an average particle diameter exceeding 3 mm and not more than 30 mm, and a porosity of 30% to 70%.

A halogen-containing gas removal method using the halogen-containing gas absorbent according to the second embodiment will be described below.

At room temperature, a gas to be processed which contains a halogen-containing gas is brought into contact with a halogen absorbent containing porous lithium-containing composite oxide particles having an average particle diameter of 3 mm (exclusive) to 30 mm (inclusive), and a porosity of 30% to 70%. Consequently, the lithium-containing composite oxide particles react with and absorb the halogen-containing gas in the gas to be processed in accordance with any of formulas 6 to 14 presented earlier. Since this reaction requires no water, the halogen-containing gas can be efficiently absorbed and removed from the dried gas to be processed. Also, since the porosity of the lithium-containing composite oxide particles having an average particle diameter exceeding 3 mm and not more than 30 mm, and a porosity of 30% to 70%, the gas to be processed can be well supplied between the lithium-containing composite oxide particles. In addition, the ratio of contact with the halogen-containing gas can be increased-by increasing the specific surface area. This also makes it possible to efficiently absorb and remove the halogen-containing gas.

The gas to be processed preferably contains 0.1% to 5.0% by volume, of the halogen-containing gas. If the amount of halogen-containing gas in the gas to be processed falls outside this range, the efficiency of absorption of the halogen-containing gas by the absorbent may decrease.

Examples of the gas to be processed are a dried dry etching gas which is exhausted as a waste gas after dry etching and contains a halogen-containing gas and an inert gas such as argon or nitrogen, and a halogen-containing gas which is vaporized in cleaning process.

A halogen-containing gas processing apparatus including the halogen-containing gas absorbent according to the second embodiment has the same structure as FIG. 1 explained in the first embodiment.

The present invention will be described in more detail below by way of examples.

### EXAMPLE 1

A powder mixture was obtained by mixing a silicon oxide powder having an average particle diameter of 1 μm as a metal oxide powder and a lithium carbonate powder having an average particle diameter of 1 μm at a molar ratio of 1:2. This powder mixture was sintered in the atmosphere at 900° C. to form a lithium-containing composite oxide (Li₄SiO₄) powder having an average particle diameter of 1 μm.

The obtained lithium-containing composite oxide powder and PVA as a binder resin were mixed at a weight ratio of 1:0.01, and the mixture was formed into particles (granules) having an average particle diameter of 500 μm by a rolling method, thereby manufacturing a halogen-containing gas absorbent.

The halogen-containing gas absorption characteristics of the obtained halogen-containing gas absorbent were evaluated as follows.

Fifty grams of the halogen-containing gas absorbent were packed in a cylindrical columnar of 10 mm in diameter and 50 mm in length having two closed ends at which a supply port and exhaust port were formed. A gas to be processed was supplied from the supply port and passed through the absorbent, thereby bringing the halogen-containing gas absorbent and gas to be processed into contact with each other. After that, the gas to be processed was exhausted via the exhaust port. The gas to be processed was a gas mixture of 99% of nitrogen gas and 1% of HCl gas at a temperature of 10° C., and was allowed to flow at a gas flow rate of 1 L/sec for 180 min.

After the gas to be processed was thus passed through the halogen-containing gas absorbent, the crystalline phase of the absorbent was identified by an X-ray diffraction apparatus. As a consequence, the constituent phase was a mixture of silicon oxide and lithium chloride. Also, the weights of the halogen-containing gas absorbent were measured before and after the process, and the absorption amount of the halogen-containing gas (hydrogen chloride gas) was calculated from the increase in weight. The results are shown in Table 1 below.

### EXAMPLES 2-4 & COMPARATIVE EXAMPLE 1

Four types of halogen-containing gas absorbents having average particle diameters shown in Table 1 below were manufactured by performing a rolling method under different conditions or by a spray dry method, by using the same lithium-containing composite oxide (Li₄SiO₄) powder as in Example 1 having an average particle diameter of 1 μm.

The halogen-containing gas (hydrogen chloride gas) absorption amounts of the obtained halogen-containing gas absorbents of Examples 2 to 4 and Comparative Example 1 were calculated in the same manner as in Example 1. The results are shown in Table 1 below.

### EXAMPLES 5 & 6

The same halogen-containing gas absorbent as in Example 1 was used to calculate halogen-containing gas absorption amounts in the same manner as in Example 1 except that HF gas and ClF₃ gas were used instead of HCl as halogen-containing gases in gases to be processed. The results are shown in Table 1 below.

### EXAMPLES 7-12

Six types of halogen-containing gas absorbents were manufactured following the same procedures as in Example 1 except that the type of metal oxide powder and the ratio of the metal oxide powder to the lithium carbonate powder were changed.

The halogen-containing gas (hydrogen chloride gas) absorption amounts of the obtained halogen-containing gas absorbents of Examples 7 to 12 were calculated in the same manner as in Example 1. The results are shown in Table 1 below.

### COMPARATIVE EXAMPLE 2

A halogen-containing gas absorption amount was calculated in the same manner as in Example 1 by using a halogen-containing gas absorbent made of soda lime having an average particle diameter of 500 μm. The result is shown in Table 1 below.

Table 1 below also shows the porosity of each halogen-containing gas absorbent measured by a mercury penetration method.

TABLE 1

| | Halogen-containing | | | | |
|---|---|---|---|---|---|
| | gas absorbent | | | Type of | Absorption |
| | | Average | | halogen- | amount (g) of |
| | | particle | | containing | halogen- |
| | Material | diameter | Porosity | gas | containing gas |
| Example 1 | Li₄SiO₄ | 15 mm | 40 | HCl | 3.7 |
| Example 2 | Li₄SiO₄ | 1 mm | 30 | HCl | 7.3 |
| Example 3 | Li₄SiO₄ | 3 mm | 35 | HCl | 5.9 |
| Example 4 | Li₄SiO₄ | 50 μm | 30 | HCl | 8.3 |
| Comparative | Li₄SiO₄ | 10 μm | 25 | HCl | 0.3 |
| Example 1 | | | | | |
| Example 5 | Li₄SiO₄ | 500 μm | 30 | HF | 12.1 |
| Example 6 | Li₄SiO₄ | 500 μm | 30 | ClF₃ | 7.9 |
| Example 7 | Li₂SiO₃ | 500 μm | 30 | HCl | 7.3 |
| Example 8 | Li₂ZrO₃ | 500 μm | 30 | HCl | 3.8 |
| Example 9 | LiFeO₂ | 500 μm | 30 | HCl | 3.3 |
| Example 10 | LiNiO₂ | 500 μm | 30 | HCl | 2.9 |
| Example 11 | Li₂TiO₃ | 500 μm | 30 | HCl | 3.4 |
| Example 12 | LiAlO₂ | 500 μm | 30 | HCl | 3.2 |
| Comparative | Soda | 500 μm | 30 | HCl | 0.4 |
| Example 2 | lime | | | | |

As shown in Table 1, the halogen-containing gas absorbents of Examples 1 to 12 containing lithium-containing composite oxide particles having average particle diameters of 50 tm to 3 mm efficiently absorbed the halogen-containing gases from the dried gases to be processed.

In contrast, the halogen-containing gas absorbent of Comparative Example 1 containing lithium-containing composite oxide particles having an average particle diameter of less than 50 μm had a halogen-containing gas absorption amount smaller than those of the halogen-containing gas absorbents of Examples 1 to 12.

Also, the halogen-containing gas absorbent of Comparative Example 2 made of soda lime had a halogen-containing gas absorption amount very much smaller than those of the halogen-containing gas absorbents of Examples 1 to 12. This is because the dried gas to be processed had no water necessary for the reaction, indicated by formula (1) presented earlier, between the halogen-containing gas absorbent made of soda lime and the halogen-containing gas, and so the halogen-containing gas absorption reaction could not progress well.

### EXAMPLE 13

A halogen-containing gas absorbent having a particle diameter of 15 mm was obtained by compression-molding the same lithium-containing composite oxide (Li₄SiO₄) powder as in Example 1 having an average particle diameter of 1 μm in a mold. The porosity of this absorbent measured by a mercury penetration method was 40%.

The halogen-containing gas absorption characteristics of the obtained halogen-containing gas absorbent were evaluated by the following method.

Fifty grams of the halogen-containing gas absorbent were packed in a cylindrical member of 30 mm in diameter and 100 mm in length having two closed ends at which a supply port and exhaust port were formed. A gas to be processed was supplied from the supply port and passed through the absorbent, thereby bringing the halogen-containing gas absorbent and gas to be processed into contact with each other. After that, the gas to be processed was exhausted via the exhaust port. The gas to be processed was a gas mixture of 99% of nitrogen gas and 1% of HCl gas at a temperature of 10° C., and was allowed to flow at a gas flow rate of 1 L/sec for 180 min.

The results are shown in Table 2 below.

### EXAMPLES 14-16 & COMPARATIVE EXAMPLES 3-5

Six types of halogen-containing gas absorbents having porosities and average particle diameters shown in Table 2 below were manufactured by changing the pressure, by using the same lithium-containing composite oxide (Li₄SiO₄) powder as in Example 1 having an average particle diameter of 1 μm.

The halogen-containing gas (hydrogen chloride gas) absorption amounts of the obtained halogen-containing gas absorbents of Examples 14 to 16 and Comparative Example 3 to 5 were calculated in the same manner as in Example 13. The results are shown in Table 2 below.

### EXAMPLES 17-20

Four types of halogen-containing gas absorbents having porosities and average particle diameters shown in Table 2 below were manufactured following the same procedures as in Example 13 except that the type of metal oxide powder and the ratio of the metal oxide powder to the lithium carbonate powder were changed.

The halogen-containing gas (hydrogen chloride gas) absorption amounts of the obtained halogen-containing gas absorbents of Examples 17 to 20 were calculated in the same manner as in Example 13. The results are shown in Table 2 below.

Table 2 below also shows the porosity of each halogen-containing gas absorbent measured by a mercury penetration method.

TABLE 2

| | Halogen-containing | | | | |
|---|---|---|---|---|---|
| | gas absorbent | | | Type of | Absorption |
| | | Average | | halogen- | amount (g) of |
| | | particle | | containing | halogen- |
| | Material | diameter | Porosity | gas | containing gas |
| Example 13 | Li₄SiO₄ | 15 mm | 40% | HCl | 48.6 |
| Example 14 | Li₄SiO₄ | 30 mm | 40% | HCl | 44.2 |
| Example 15 | Li₄SiO₄ | 15 mm | 30% | HCl | 37.4 |
| Example 16 | Li₄SiO₄ | 15 mm | 70% | HCl | 58.2 |
| Comparative | Li₄SiO₄ | 50 mm | 40% | HCl | 6.4 |
| Example 3 | | | | | |
| Comparative | Li₄SiO₄ | 15 mm | 20% | HCl | 3.5 |
| Example 4 | | | | | |
| Comparative | Li₄SiO₄ | 15 mm | 80% | HCl | 8.4 |
| Example 5 | | | | | |
| Example 17 | Li₂SiO₃ | 15 mm | 40% | HCl | 37.4 |
| Example 18 | Li₂ZrO₃ | 15 mm | 40% | HCl | 26.7 |
| Example 19 | LiFeO₂ | 15 mm | 40% | HCl | 17.9 |
| Example 20 | LiNiO₂ | 15 mm | 40% | HCl | 18.8 |

As shown in Table 2, the halogen-containing gas absorbents of Examples 13 to 20 containing porous lithium-containing composite oxide particles having average particle diameters exceeding 3 mm and not more than 30 mm and porosities of 30% to 70% efficiently absorbed a halogen-containing gas from a dried gas to be processed.

In contrast, the halogen-containing gas absorbent of Comparative Example 3 containing lithium-containing composite oxide particles having an average particle diameter exceeding 30 mm and the halogen-containing gas absorbents of Comparative Examples 4 and 5 having average particle diameters exceeding 3 mm and not more than 30 mm and porosities falling outside the above range had halogen-containing gas absorption amounts smaller than those of the halogen-containing gas absorbents of Examples 13 to 20.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

1. A halogen-containing gas absorbent comprising lithium-containing composite oxide particles having an average particle diameter of 50 μm to 3 mm.

2. An absorbent according to claim 1, wherein the average particle diameter of the lithium-containing composite oxide particles is in the range of 500 μm to 2 mm.

3. A halogen-containing gas absorbent comprising porous lithium-containing composite oxide particles having an average particle diameter exceeding 3 mm and not more than 30 mm, and a porosity of 30% to 70%.

4. An absorbent according to claim 3, wherein the porosity of the porous lithium-containing composite oxide particles is in the range of 40% to 60%.

5. An absorbent according to claim 3, wherein the average particle diameter of the porous lithium-containing composite oxide particles is in the range of 5 mm to 20 mm.

6. A halogen-containing gas removal method comprising bringing a gas to be processed which contains a halogen-containing gas, into contact with a halogen-containing gas absorbent comprising lithium-containing composite oxide particles having an average particle diameter of 50 μm to 3 mm.

7. A method according to claim 6, wherein the average particle diameter of the lithium-containing composite oxide particles is in the range of 500 μm to 2 mm.

8. A method according to claim 6, wherein the gas to be processed contains 0.1% to 5.0% by volume, of the halogen-containing gas.

9. A method according to claim 6, wherein the gas to be processed is a dry etching gas which is exhausted as a waste gas and contains a halogen-containing gas and inert gas.

10. A halogen-containing gas removal method comprising bringing a gas to be processed which contains a halogen-containing gas, into contact with a halogen-containing gas absorbent containing porous lithium-containing composite oxide particles having an average particle diameter exceeding 3 mm and not more than 30 mm, and a porosity of 30% to 70%.

11. A method according to claim 10, wherein the average particle diameter of the porous lithium-containing composite oxide particles is in the range of 5 mm to 20 mm.

12. A method according to claim 10, wherein the porosity of the porous lithium-containing composite oxide particles is in the range of 40% to 60%.

13. A method according to claim 10, wherein the gas to be processed contains 0.1% to 5.0% by volume, of the halogen-containing gas.

14. A method according to claim 10, wherein the gas to be processed is a dry etching gas which is exhausted as a waste gas and contains a halogen-containing gas and inert gas.

15. A halogen-containing gas processing apparatus comprising:
a vessel having a supply port through which a gas containing a halogen-containing gas is supplied, and an exhaust port; and
a halogen-containing gas absorbent packed in the vessel and comprising lithium-containing composite oxide particles having an average particle diameter of 50 μm to 3 mm.

16. A halogen-containing gas processing apparatus comprising:
a vessel having a supply port through which a gas containing a halogen-containing gas is supplied, and an exhaust port; and
a halogen-containing gas absorbent packed in the vessel and comprising porous lithium-containing composite oxide particles having an average particle diameter exceeding 3 mm and not more than 30 mm, and a porosity of 30% to 70%.
